(19) United States
(12) Patent Application Publication
(10) Pub. No.: US 2026/0118740 A1
(43) Pub. Date: Apr. 30, 2026

(54) ASSEMBLY METHOD OF ZOOM LENS

(71) Applicant: Kinko Optical Co.,Ltd., Taichung City (TW)

(72) Inventor: Chin-Chieh Lin, Taichung City (TW)

(21) Appl. No.: 19/053,664

(22) Filed: Feb. 14, 2025

(30) Foreign Application Priority Data
Oct. 30, 2024 (TW) 113141742

(51) Int. Cl. G03B 17/14; G02B 15/14

(52) U.S. Cl. CPC G03B 17/14; G02B 15/14

(57) ABSTRACT

An assembly method of a zoom lens includes: providing a lens barrel that has an object-side end, an image-side end, a barrel body, and two circuit pins, wherein the image-side end has an assembly hole, the barrel body has two circuit grooves and two radial holes each matching one of the circuit grooves, and the two circuit pins are each provided in one of the circuit grooves and the matching radial hole; mounting a front lens group, a zoom lens assembly, and a rear lens group sequentially into the lens barrel through the assembly hole, wherein the zoom lens assembly includes a spacer ring, a deformable lens, and two lens assembly pins; securing the front lens group, the zoom lens assembly, and the rear lens group to the lens barrel separately; and electrically connecting each of the lens assembly pins with the matching circuit pin through an electrically conductive adhesive.

### BACKGROUND OF THE INVENTION

### 1. Technical Field

The present invention relates to the assembly method of an optical lens. More particularly, the invention relates to the assembly method of a zoom lens.

### 2. Description of Related Art

Autofocus lenses are a type of zoom lenses that are widely used. Many zoom lenses have a deformable lens, such as TLens™, between the front and rear lens groups.

The existing assembly process of a zoom lens is generally as follows. The front and rear lens groups of the zoom lens are mounted in a front lens barrel and a rear lens barrel respectively in the lens factory. During the mounting process, an alignment-module machine must be used to verify the resolution quality of each of the front and rear lens groups. After that, the preliminarily assembled front and rear lens groups and a deformable lens are transported to a module factory, where the deformable lens is secured to the rear lens barrel and electrically connected to the circuit pins of the rear lens barrel, and where the front and rear lens barrels are subsequently put together and secured to each other. The assembly and securing processes in the module factory also require the use of an alignment-module machine to verify resolution quality, and only after the verification can the front and rear lens barrels be assembled and then transferred to an active alignment (AA) machine in order to be mounted with a sensor module and go through further adjustment.

The foregoing prior art has the following shortcomings. The assembly process of each of the front and rear lens groups entails resolution verification by an alignment-module machine and therefore takes a relatively long time, which slows down mass production. The backend module factory must also use an alignment-module machine to mount the deformable lens on the rear lens barrel and to adjust the resolutions of the front and rear lens groups, and this further prolongs the manufacturing process of the zoom lens.

### BRIEF SUMMARY OF THE INVENTION

In view of the above, the primary objective of the present invention is to provide a lens assembly method that can save the time required for manufacturing the lens.

To achieve the above and other objectives, the present invention provides an assembly method of a zoom lens, and the assembly method includes the following steps:

To start with, a lens barrel is provided. The lens barrel has an object-side end, an image-side end, a barrel body, and a pair of circuit pins. The object-side end has a light input hole. The image-side end has an assembly hole. The barrel body has a pair of circuit grooves and a pair of radial holes, wherein each radial hole matches one of the pair of circuit grooves. The pair of circuit pins are each provided in one of the circuit grooves and the radial hole matching the one of the circuit grooves.

Next, a front lens group, a zoom lens assembly, and a rear lens group are mounted into the lens barrel through the assembly hole one after another. The front lens group includes at least one front-lens-group lens. The rear lens group includes at least one rear-lens-group lens. The zoom lens assembly includes a spacer ring, a deformable lens provided in the spacer ring, and a pair of lens assembly pins, wherein each lens assembly pin matches one of the pair of circuit pins.

Following that, the front lens group, the zoom lens assembly, and the rear lens group are secured to the lens barrel separately.

Lastly, each of the pair of lens assembly pins is electrically connected to the matching circuit pin by an electrically conductive adhesive.

According to the present invention, the front lens group, the zoom lens assembly, and the rear lens group are sequentially put into a single lens barrel in a single operation. This helps solve the prior art problem that it takes a lot of time to assemble the front and rear lens groups individually. In consequence, product yield can be increased, and the load on the module factory responsible for assembly can be reduced.

### BRIEF DESCRIPTION OF THE SEVERAL VIEWS OF THE DRAWINGS

FIG. 1 is a perspective view of the lens barrel in the first embodiment of the present invention.

FIG. 2 is a sectional view of the lens barrel in the first embodiment of the present invention.

FIG. 3 is a perspective view of the zoom lens assembly in the first embodiment of the present invention.

FIG. 4 is a sectional view of the front lens group, zoom lens assembly, and rear lens group in the first embodiment of the present invention after they are mounted in the lens barrel.

### DETAILED DESCRIPTION OF THE INVENTION

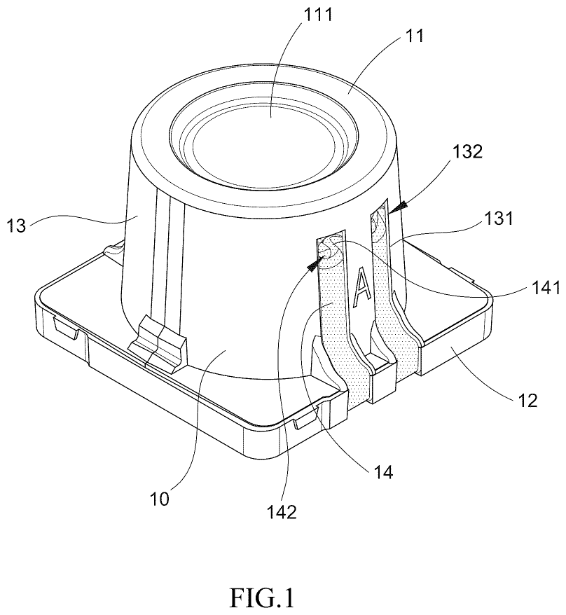

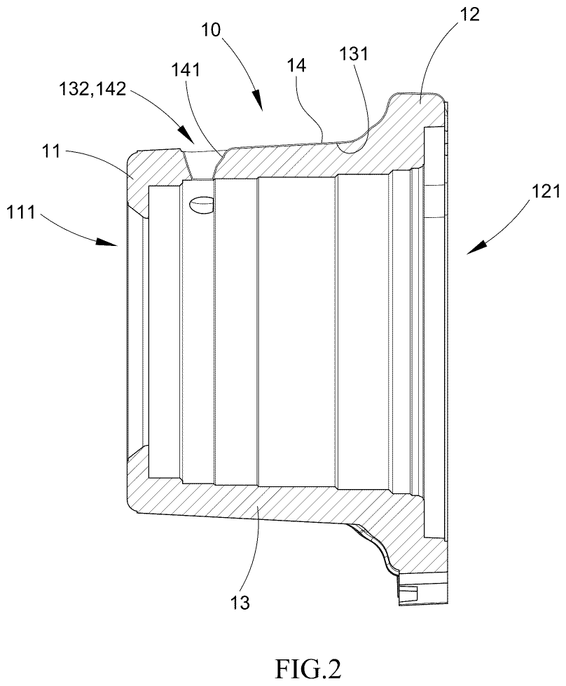

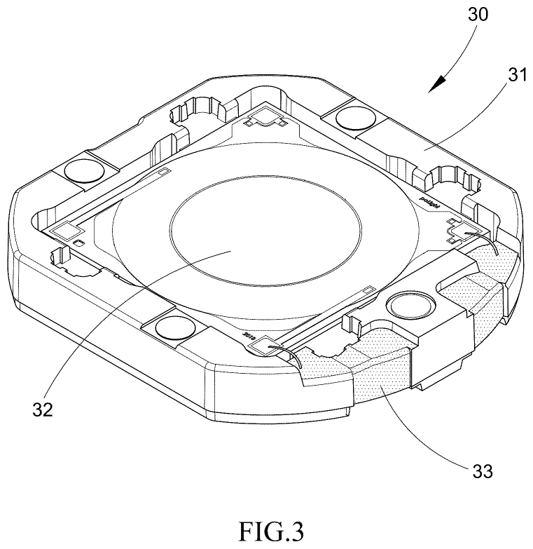

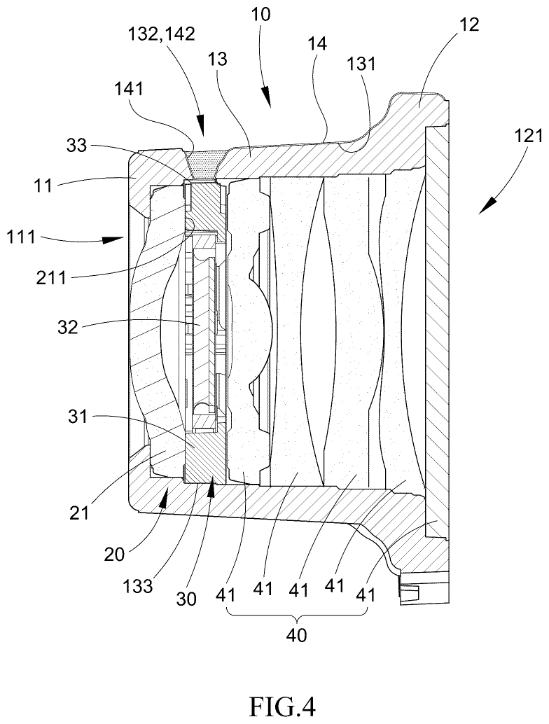

Referring to FIG. 1 to FIG. 4 for the first embodiment of the present invention, the assembly method provided by the invention for a zoom lens includes the following steps:

A lens barrel 10 is provided. The lens barrel 10 includes an object-side end 11, an image-side end 12, a barrel body 13, and a pair of circuit pins 14. The object-side end 11 has a light input hole 111. The image-side end 12 has an assembly hole 121. The barrel body 13 has a pair of circuit grooves 131 and a pair of radial holes 132, wherein each radial hole 132 matches one of the pair of circuit grooves 131. Each of the circuit pins 14 is provided in one of the circuit grooves 131 and the radial hole 132 matching the one of the circuit grooves 131. More specifically, each circuit pin 14 has a hollow conical body 141 provided in the corresponding radial hole 132, and each hollow conical body 141 defines an adhesive receiving hole 142 for receiving an electrically conductive adhesive. The circuit pins 14 may be made by, for example but not limited to, laser direct structuring.

Following that, a front lens group 20, a zoom lens assembly 30, and a rear lens group 40 are mounted sequentially into the lens barrel 13 through the assembly hole 121. The front lens group 20 includes at least one front-lens-group lens 21 (in this embodiment, one front-lens-group lens 21 is used by way of example). The rear lens group 40 includes at least one rear-lens-group lens 41 (in this embodiment, a plurality of rear-lens-group lenses 41 are used by way of example). In a feasible mode of implementation, each of the front and rear lens groups 20 and 40 may include at least one aperture or include no aperture at all. The zoom lens assembly 30 includes a spacer ring 31, a deformable lens 32 provided in the spacer ring 31, and a pair of lens assembly pins 33, wherein each lens assembly pin 33 matches one of the pair of circuit pins 14. The lens assembly pins 33 may be provided on the spacer ring 31 by, for example but not limited to, laser direct structuring. The deformable lens 32 may be secured to the spacer ring 31 by a UV-curable adhesive, before being connected to the lens assembly pins 33 by wire bonding. In a feasible mode of implementation, the deformable lens 32 includes a glass container containing a polymer, and a pressure is applied to the container by an electromagnetic actuator in order to curve the deformable lens 32, meaning the electromagnetic actuator can be used to control the focal length of the deformable lens 32. In the front lens group 20, the front-lens-group lens 21 closest to the zoom lens assembly 30 has an abutting surface 211 against which the spacer ring 31 can abut so as to fix the assembly depth of the zoom lens assembly 30. In addition, the barrel body 13 has a lens assembly receiving groove 133 whose contour matches that of the spacer ring 31 to contribute to radial positioning of the zoom lens assembly 30 and to ensure coaxiality. It should be pointed out that, as used herein, the term “front lens group” refers generally to the lens or lenses (plus the corresponding aperture(s), if any) that are closer to the object-side end 11 than is the zoom lens assembly 30, whereas the term “rear lens group” refers generally to the lens or lenses (plus the corresponding aperture(s), if any) that are closer to the image-side end 12 than is the zoom lens assembly 30.

Next, the front lens group 20, the zoom lens assembly 30, and the rear lens group 40 are secured to the lens barrel 13 separately, e.g., by a light-curable adhesive. Before the securing step is performed, the resolving power of the front and rear lens groups 20 and 40 and of the zoom lens assembly 30 can be tested directly with a lens MTF (modulation transfer function) testing machine in a single operation, i.e., without having to test the front and rear lens groups 20 and 40 individually.

Lastly, an electrically conductive adhesive is used to form electrical connection between each of the pair of lens assembly pins 33 and the matching one of the pair of circuit pins 14. All the foregoing steps can be completed in a lens factory. A downstream module factory, therefore, only has to mount a sensor module on the lens barrel having completed the assembly process and make necessary adjustment, and these mounting and adjusting processes no longer require an alignment-module machine. Consequently, the process flow of manufacture of the zoom lens product is simplified in comparison with that of the prior art.

What is claimed is:

1. An assembly method of a zoom lens, comprising the steps of:
providing a lens barrel, wherein the lens barrel has an object-side end, an image-side end, a barrel body, and a pair of circuit pins, the object-side end has a light input hole, the image-side end has an assembly hole, the barrel body has a pair of circuit grooves and a pair of radial holes, each said radial hole matches one of the pair of circuit grooves, and the pair of circuit pins are each provided in one of the pair of circuit grooves and the radial hole matching the one of the pair of circuit grooves;
mounting a front lens group, a zoom lens assembly, and a rear lens group sequentially into the lens barrel through the assembly hole, wherein the front lens group comprises at least one front-lens-group lens, the rear lens group comprises at least one rear-lens-group lens, the zoom lens assembly comprises a spacer ring, a deformable lens provided in the spacer ring, and a pair of lens assembly pins, and each said lens assembly pin matches one of the pair of circuit pins;
securing the front lens group, the zoom lens assembly, and the rear lens group to the lens barrel separately; and
forming electrical connection between each of the pair of lens assembly pins and a matching one of the pair of circuit pins through an electrically conductive adhesive.

2. The assembly method of a zoom lens as claimed in claim 1, wherein each said circuit pin has a hollow conical body provided in a corresponding one of the radial holes, and each said hollow conical body defines an adhesive receiving hole for receiving the electrically conductive adhesive.

3. The assembly method of a zoom lens as claimed in claim 1, wherein one of the at least one front-lens-group lens has an abutting surface against which the spacer ring is able to abut.

4. The assembly method of a zoom lens as claimed in claim 1, wherein the barrel body has a lens assembly receiving groove, and the lens assembly receiving groove has a contour matching a contour of the spacer ring.
